(19) United States
(12) Patent Application Publication
(10) Pub. No.: US 2008/0307426 A1
(43) Pub. Date: Dec. 11, 2008

(54) DYNAMIC LOAD MANAGEMENT IN HIGH AVAILABILITY SYSTEMS

(75) Inventor: Maria Toeroe, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/130,404

(22) Filed: May 30, 2008

Related U.S. Application Data
(60) Provisional application No. 60/942,138, filed on Jun. 5, 2007.

(51) Int. Cl. G06F 9/48

(52) U.S. Cl. 718/104

(57) ABSTRACT

Techniques for dynamic load management in processing systems are described. Tuples or vectors, for example, can be used to characterize loads and capacities. Assignments of tasks and redistribution of tasks in the system can be made using the tuples or vectors.

### RELATED APPLICATION

This application is related to, and claims the benefit of priority from, U.S. Provisional Patent Application Ser. No. 60/942,138, filed on Jun. 5, 2007, the disclosure of which is expressly incorporated by reference herein.

### TECHNICAL FIELD

The present invention generally relates to high availability systems (hardware and software) and, more particularly, to managing workloads associated with such high availability (or other) systems.

### BACKGROUND

High availability systems (also known as HA systems) are systems that are implemented primarily for the purpose of improving the availability of services which the systems provide. Availability can be expressed as a percentage of time during which a system or service is “up”. For example, a system designed for 99.999% availability (so called “five nines” availability) refers to a system or service which has a downtime of only about 0.44 minutes/month or 5.26 minutes/year.

High availability systems provide for a designed level of availability by employing redundant nodes, which are used to provide service when system components fail. For example, if a server running a particular application crashes, an HA system will detect the crash and restart the application on another, redundant node. Various redundancy models can be used in HA systems. For example, an N+1 redundancy model provides a single extra node (associated with a number of primary nodes) that is brought online to take over the role of a node which has failed. However, in situations where a single HA system is managing many services, a single dedicated node for handling failures may not provide sufficient redundancy. In such situations, an N+M redundancy model, for example, can be used wherein more than one (M) standby nodes are included and available.

As HA systems become more commonplace for the support of important services such file sharing, internet customer portals, databases and the like, it has become desirable to provide standardized models and methodologies for the design of such systems. For example, the Service Availability Forum (SAF) has standardized application interface services (AIS) to aid in the development of portable, highly available applications. As shown in the conceptual architecture stack of FIG. 1, the AIS 10 is intended to provide a standardized interface for the HA middleware 16 and supports HA applications 14. As described below, each set of AIS functionality is associated with an operating system 20 and a hardware platform 22. The reader interested in more information relating to the AIS standard specification is referred to Application Interface Specifications (AIS), Release 5, which is available at www.saforum.org, the disclosure of which is incorporated here by reference.

Of particular interest for the present application is the Availability Management Framework (AMF), which is a software entity defined within the AIS specification. According to the AIS specification, the AMF is a standardized mechanism for providing service availability by coordinating redundant resources within a cluster to deliver a system with no single point of failure. The AMF provides a set of application program interfaces (APIs) through which an AMF implementation compliant to this specification determines, among other things, the states of components within a cluster and the health of those components. The components are also provided with the capability to query the AMF for information about their state. An application which is developed using the AMF APIs and following the AMF system model leaves the burden of managing the availability of its services to the AMF. Thus, such an application does not need to deal with dynamic reconfiguration issues related to component failures, maintenance, etc.

Among other things, the AMF specification provides for an entity known as an availability manager. In an HA cluster, an availability manager redistributes tasks dynamically as a result of, e.g., node failures and administrative operations. With the redistribution of tasks, the workload distribution in the HA cluster also changes, since these tasks represent workloads. However, redistributing tasks is complicated by the fact that the characteristics of both tasks and resources may vary widely from system to system.

Accordingly, it would be desirable to provide methods, devices and systems and software for dynamic load management in, for example, high availability systems.

### SUMMARY

According to one exemplary embodiment, a method for making load characteristics of a serving entity available, wherein the serving entity is a logical or physical entity, the method includes the steps of obtaining a capacity approximation of the serving entity for each one of more than one resource, obtaining a load approximation of the serving entity for each one of the more than one resource, and making a utilization of the serving entity available by listing a respective capacity approximation and load approximation for each one of the more than one resources.

According to another exemplary embodiment, a method for assigning a task to a node in a network includes the steps of obtaining a vector of load values associated with the task (e.g., representing a particular workload), each value in the vector representing a different type of capacity associated with the task, comparing at least one value in the vector of load values with a corresponding value in a vector of capacity values associated with the node, and assigning the task to the node if the comparing indicates that the node can supply at least one of the different types of capacity associated with the task.

According to still another exemplary embodiment, a device includes a memory device for storing vectors of load values associated with tasks to be assigned, each value in each of the vectors of load values representing a different type of capacity associated with a respective task, and for storing vectors of capacity values associated with nodes which can perform tasks, each value in each of the vectors of capacity values representing the different type of capacity provided by a respective node, and a processor which compares at least one value in a selected vector of load values associated with a task to be assigned with a corresponding value in a selected vector of capacity values associated with one of the nodes, and which assigns the task to the node if the comparison indicates that the node can supply at least one of the different types of capacity associated with by the task.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conceptual architecture stack associated with application interface services (AIS);

FIGS. 2(a) and 2(b) illustrate characterizations of loads and capacities using a single number;

FIG. 3 depicts distributed platform management according to an exemplary embodiment;

FIG. 4 illustrates characterizations of loads and capacities using tuples or vectors according to an exemplary embodiment;

FIGS. 5(a)-5(c) show exemplary tasks and utilizations made using characterizations of loads and capacities using tuples or vectors according to an exemplary embodiment;

FIG. 6 depicts a node which can use tuples or vectors as characterizations of loads and capacities according to various exemplary embodiments; and

FIGS. 7 and 8 are flowcharts of methods according to exemplary embodiments.

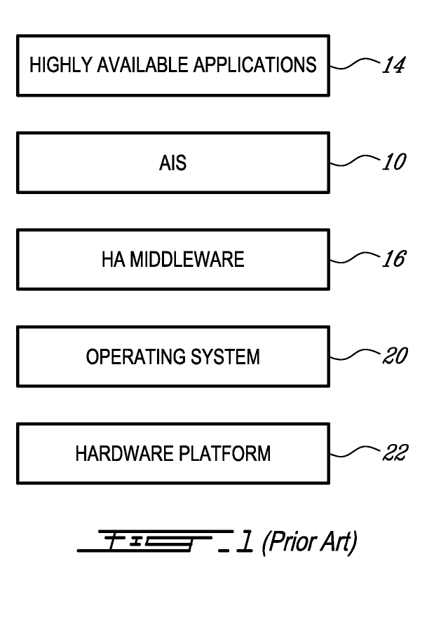

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

In performing the redistribution of tasks, it is important that the availability manager can take into account (a) a particular node's capacity, (b) that node's current utilization and (c) the workload represented by a particular task, when moving a task to a new servicing node. One way for an availability manager to track this information for redistributing tasks is to have a capacity value assigned to each node and a load value to each task. Then, the availability manager can calculate the utilization based on the current tasks of the node.

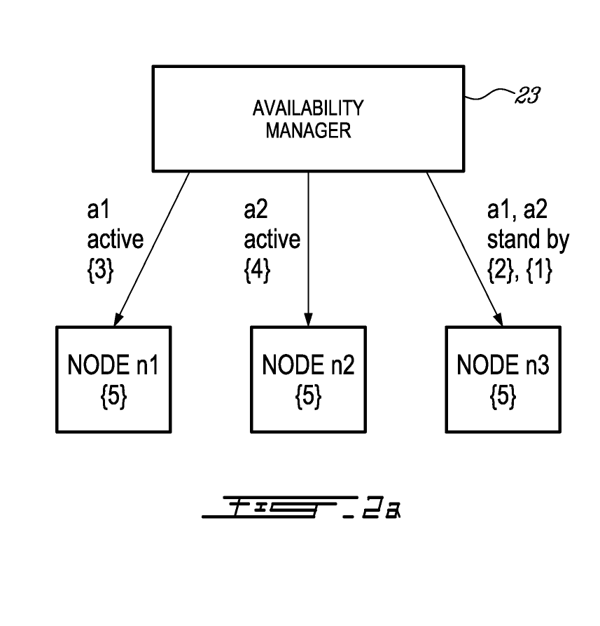

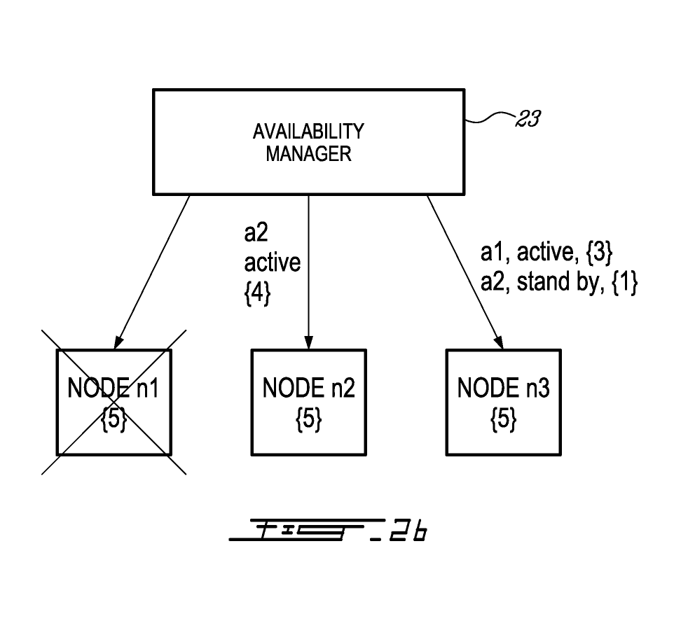

For example, consider the exemplary HA system illustrated in FIG. 2(a). Therein, three nodes n1, n2 and n3 are managed by an availability manager 23 which has two workload tasks a1 and a2 that it is managing. Suppose that each of the nodes have a capacity value of {5} as shown, that task al has a load value of {3} for the active role and a load value of {2} in standby, and that task a2 has a load value of {4} for the active role and a load value of {1} for its standby role. Suppose further that, initially, all of the nodes n1-n3 are available, and that the availability manager 23 assigns node n1 to serve task a1 in the active role, node n2 to serve task a2 in the active role and node n3 to serve both tasks a1 and a2 in the standby.

For this example, the availability manager 23 can therefore calculate the node utilizations to be n1={3/5}, n2={4/5} and n3={3/5} using the single number capacity values shown in FIG. 2(a). Thus, if node n1 fails, as shown in FIG. 2(b), availability manager 23 can use this information to recognize that node n3 can take on task a1 in the active role and remain in the standby role for task a2, since node n3's utilization then becomes n3={4/5} after this reassignment of the roles (note that node n3 is no longer operating in the standby role for task a1 after this reassignment since it now serves task a1 in the active role). On the other hand, if node n2 fails instead of node n1, then availability manager 23 will recognize that node n3 can only serve task a2 in the active role, since keeping task al standby would exceed its capacity (i.e., n3={6/5}).

One problem with using a single number to characterize node capacities and loads, and using that single number in an availability manager to re-assign roles to the managed nodes as described above, is that serving nodes typically have different capacities with respect to memory, processing power, communication channels, and other parameters. These differences in capacities may not be comparable with one another and, therefore, trying to accurately characterize a node's relative capacity with a single number may be difficult. Similarly tasks use these capacities differently, e.g., one task may be memory intensive, while another task may be processor intensive.

Rather than using a single value to characterize the capacities and loads of resources and tasks, systems, methods, device and software according to these exemplary embodiments use multiple values, e.g., tuples or vectors, for this purpose. Each element of the tuple describes a given resource “dimension”, i.e., a value associated with a particular type of capacity or load. As a purely illustrative and simple example, a node could be characterized using a tuple of {processing power, amount of memory}, e.g., {400, 4}. As will be seen below, the capacity and/or load characterization tuple can, however, include any number of values therein and is not limited to having two values as in this example. Techniques according to these exemplary embodiments enable nodes to offer their resources (capacities) in different dimensions, tasks to be more precisely characterized in terms of these dimensions based on their usage (loads) of a combination of those resources, and availability managers to more accurately match tasks to the managed nodes. Other benefits and qualities associated with capacity or load characterization according to these exemplary embodiments will be described below.

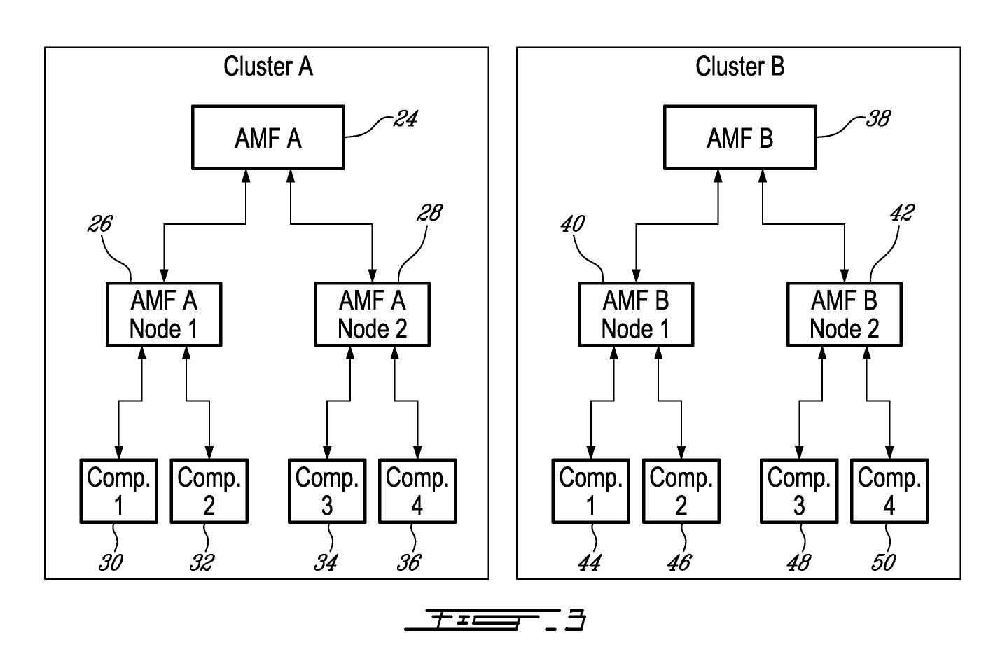

As specified in the above-described standards, each AMF availability manager (software entity) provides availability support for a single logical cluster that consists of a number of cluster nodes and components a purely illustrative example of which is shown in FIG. 3 to provide some context for the subsequent discussion on resource and load characterization. Therein, a first cluster A includes its own AMF 24, two AMF nodes 26, 28 and four AMF components 30-36. Similarly, a second cluster B has its own AMF 38, two AMF nodes 40, 42 and four AMF components 44-50. The components 30-36 and 44-50 each represent a set of hardware and software resources that are being managed by the AMFs 24 and 38, respectively. In a physical sense, components are realized as processes of an HA application. In this example, the nodes 26, 28, 40, 42 each represent a logical entity which corresponds to a physical node, however in other examples the ratio between physical nodes and logical entities could be more generally expressed as a 1:n ratio.

According to exemplary embodiments of the present invention, tuples are used to describe the capacities of nodes and corresponding loads of tasks, however the tuples can include any number of elements, which elements can relate to any type of units of measurement (or no units of measurement), and be ordered in any desired manner. Taking the foregoing example to illustrate this point, a tuple which is used to characterize capacities and loads according to these exemplary embodiments could, for example, be formatted as {processing power, amount of memory} or as {amount of memory, processing power} and could be quantified as {#MHz, #Gb}, as {#processor cores, #memory chips} or as unitless values which generally correlate in some manner to processor capabilities and memory capabilities, e.g., which are load and capacity approximations. In one exemplary embodiment of the present invention, once a particular format and order are selected for a tuple, the elements of the tuple could consistently be presented and stored in the selected order so that corresponding elements within a capacity tuple and a load tuple can be readily compared by an availability manager in order to, e.g., redistribute tasks. Alternatively, there could also be descriptive information associated with all or some of the elements of the tuple to enable proper identification of the type of information conveyed by each element. Yet another alternative could be to propagate a tuple that contains only the descriptive information that identifies the selected order of elements. Such a descriptive tuple could be exchanged each time the selected order changes (e.g., a change in the number of elements or the ordering of the elements, etc.) or the descriptive tuple could be exchanged periodically.

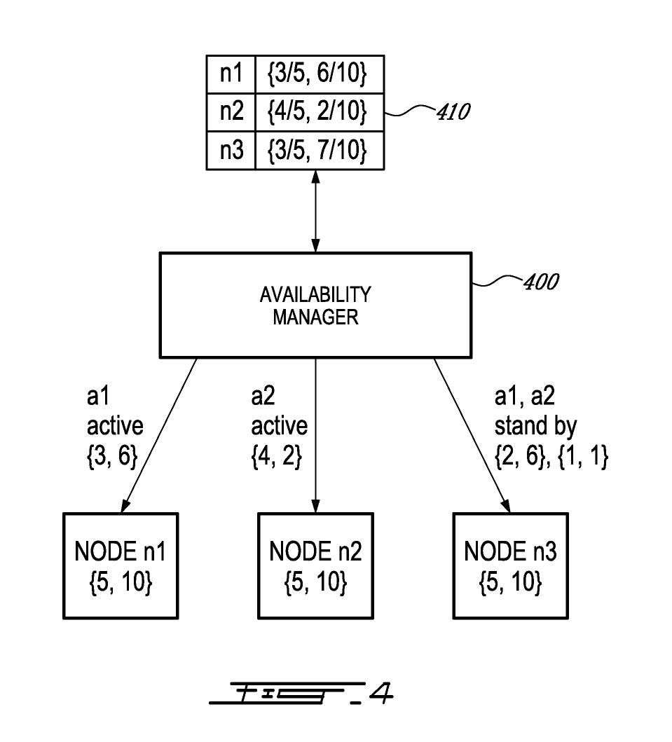

To better illustrate the usage of tuples according to these exemplary embodiments for capacity and load characterization, consider again the single number (one dimensional) example provided above with respect to FIGS. 2(a) and 2(b), and suppose that the single capacity number therein referred only to processor capacity and did not take into account memory capacity of the nodes n1-n3. This example can be modified according to these exemplary embodiments to be two dimensional, e.g., to take into account both processor capacity and memory capacity at the same time as separate dimensions. Using two dimensions and corresponding tuples, the nodes can, for example, be characterized as shown in FIG. 4(a), i.e., with capacities of n1={5, 10}, n2={5, 10}, and n3={5, 10}. In this purely illustrative example, the first element in the tuple indicates processor capacity and the second element indicates the memory capacity of each node, however as mentioned above this ordering is exemplary and arbitrary.

In order to make comparison between node (resource) capacities and task loads meaningful, the capacity tuples of the nodes and the load tuples of the tasks can have the same number of elements (dimensions) presented in the same order for a given system or implementation, or alternatively by the addition of descriptive information within each tuple or by way of a separately conveyed descriptive tuple, as described above. Thus, for the exemplary embodiment of FIG. 4, the tasks managed by availability manager 400 will be expressed, evaluated and stored as two-dimensional loads in the form of the tuple: {processor capacity, memory capacity}. For example, suppose that the task al in the active role has a load of {3, 6}, and in the standby role has a load of {2, 6}. Further suppose that task a2 has an active load of {4, 2} and a standby load of {1, 1}. As in the previous example of FIGS. 2(a) and 2(b), the availability manager 400 assigns node n1 to the active role of task a1, node n2 to the active role of task a2 and node n3 to the standby role for both tasks a1 and a2.

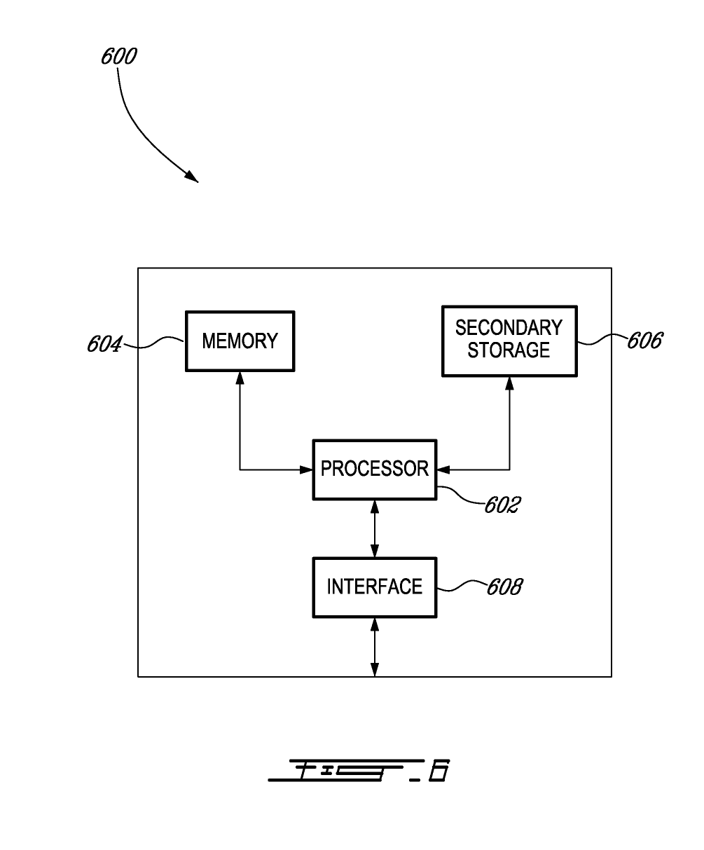

Thus, initial utilization of the nodes managed by the availability manager 400 can be expressed and stored as: n1={3/5, 6/10}, n2={4/5, 2/10}, n3={3/5, 7/10} in, e.g., table 410. This utilization information, in addition to or as an alternative to the capacity tuples of each of the nodes n1-n3 and the load tuples of each of the tasks a1 and a2, can be stored in a memory device, e.g., on the server on which availability manager 400 runs (not shown in FIG. 4 see, e.g., FIG. 6}. As in the previous example, suppose that node n1 in FIG. 4 subsequently fails and that availability manager 400 then needs to redistribute the tasks. According to this exemplary embodiment, the availability manager 400 checks the capacities and loads in each dimension of the tuples to determine how to redistribute the tasks a1 and a2 across the remaining nodes n2 and n3.

For example, when node n1 fails, its active role for task a1 will be reassigned by the availability manager 400 to node n3 based on its evaluation of the loads of tasks a1 and a2 and the capacities of nodes n2 and n3 in both dimensions. Upon reassignment, node n3 will have a utilization of {4/5, 6/10} serving in the active role for task a1 and in the standby role for task a2, which utilization value can, for example, be stored in a memory device associated with the availability manager 400. Availability manager 400 will further determine that the role of standby for task a1 cannot be reassigned given the remaining nodes' capacities, since assigning that standby role to node n2 would result in a utilization which exceeds its capacity in the first dimension, i.e., {6/5, 8/10}.

Similarly if node n2 had failed instead of node n1 in the system of FIG. 4, the availability manager 400 would reassign the active role for task a2 to node n3 and drop the standby role for task a1 based on its evaluation of the capacity and load tuples of the remaining nodes and existing tasks. Under this exemplary scenario, node n3 would have a resulting utilization of {4/5, 2/10} and availability manager 400 would further recognized that node n1 is capable of accommodating the task a2 standby role in addition to its active a1 task since the resulting utilization does not exceed its capacity in either dimension, i.e., {4/5, 7/10}.

It will be appreciated that for task redistribution according to exemplary embodiments, the availability manager 400 will typically perform a comparison between the load vector of the task to be assigned and a capacity vector associated with each node's current, free capacity, e.g., the utilization vectors described above. Alternatively each node's own capacity vector could be updated each time a task is assigned so that it represents the node's current free capacity rather than the node's total capacity when it is not performing any tasks.

Having provided one illustration of how tuples can be used to characterize capacities and loads according to these exemplary embodiments, some extensions to the foregoing concepts will now be described in order to highlight the way in which such tuples can be used to provide dynamic load management in, e.g., high availability systems. The exemplary embodiments described above refer to exemplary tuple elements which represent different types of hardware capacities and loads, but the present invention is not limited to the hardware domain. Instead, tuple elements can additionally, or alternatively, represent capacities and loads in the software domain. Moreover, tuple elements can be positively valued (as in the foregoing exemplary embodiments), but also can take negative values. For example, according to other exemplary embodiments, a positive load value increases utilization, while a negative load value adds capacity.

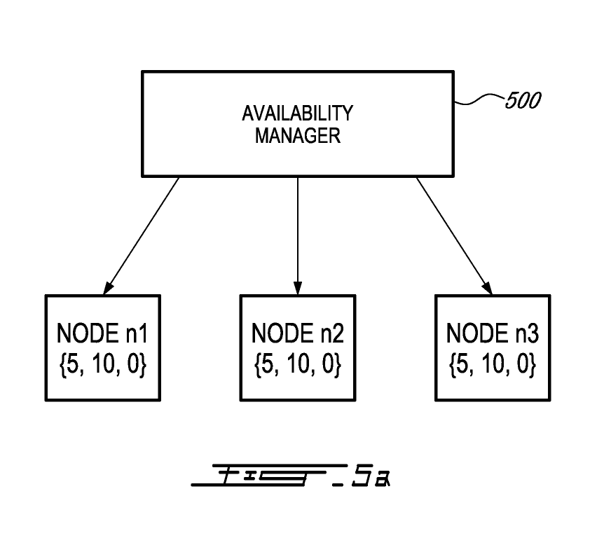

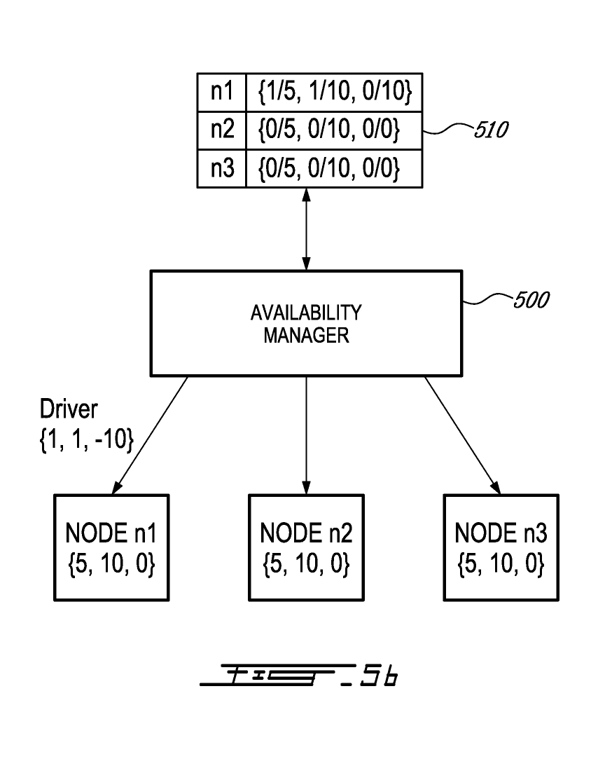

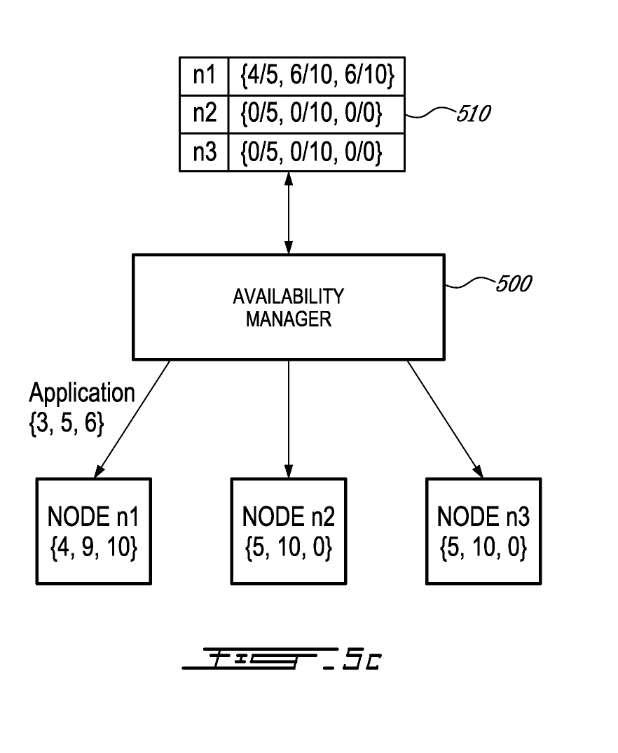

The exemplary types of capacities and loads discussed above with respect to FIG. 4, i.e., processor capacities/loads and memory capacities/loads, relate to situations where a particular hardware parameter is necessary to run software. However, it is also contemplated according to these exemplary embodiments that a particular piece of software will be needed to run another piece of software. For example, a software driver may be needed to run a particular software application. This capacity (or lack thereof) can be expressed as another element in tuples according to this exemplary embodiment. For example, using the three node system of FIG. 4 again in FIG. 5(a), each node n1-n3 would initially have no capacity in this new dimension since the software driver is not loaded on any of the nodes at startup. Thus, the capacity of each of these nodes can, for example, be expressed, evaluated and stored using the tuple {processor capacity, memory capacity, driver capacity}, e.g., n1={5, 10, 0} as shown in FIG. 5(a). Since the driver capacity of each node is initially zero, the availability manager 500 will not assign a load which requires that capacity to those nodes, e.g., a software application which needs that driver to run properly.

Suppose that the software driver's load can be represented using a tuple according to these exemplary embodiments as {1, 1, −10}, i.e., the driver uses some processor and memory capacity when assigned to a node, but provides driver capacity to that node. When this driver is assigned to node n1 by availability manager 500, that node's utilization becomes {1/5, 1/10, 0/10} as shown in FIG. 5(b). Now, the node n1 is capable of taking on a task that generates load in this third, new dimension. Accordingly, if availability manager 500 needs to assign a task to one of the nodes which has a load of {3, 5, 6}, it can now assign that task to node n1 as shown in FIG. 5(c) whereas it could not have assigned that task prior to loading the driver onto node n1. The node utilization for node n1 becomes {4/5, 6/10, 6/10} as shown in table 510 of FIG. 5(c).

The availability manager 500 can use the tuple element values according to these exemplary embodiments to match loads with capacities of various nodes in an ongoing, dynamic way to take into account the way in which capacities can change over time, including, e.g., the addition of new capacity dimensions to nodes as described above. Similarly, loads and capacities can be removed during the lifecycle of a system according to these exemplary embodiments. If a task is withdrawn by the availability manager 500, the corresponding load is taken away from its stored utilization tuples. For example, if the driver described in the foregoing exemplary embodiment is stopped or removed, node n1's utilization would become {3/5, 5/10, 6/0}, where the element value of 6/0 in the third indexed tuple element indicates that the application which uses that driver user cannot run any more on node n1 and needs to withdrawn from the node too by availability manager 500.

Approaches for characterizing capacities and loads using tuples having a plurality of dimension elements according to these exemplary embodiments provide a flexible mechanism which is capable of representing different aspects of capacities and loads. These exemplary embodiments are also capable of reflecting software/hardware dependencies in a generic way and, therefore, can be used to characterize loads and capacities for many different types of systems in addition to the aforedescribed HA clusters. Numerous variations and permutations on the foregoing exemplary embodiments are also envisioned. For example, the elements of loads and capacities expressed within the tuples according to these exemplary embodiments can be valued such that they are comparable within their own dimension, but need not be comparable between dimensional elements. Moreover, within each dimension, the element values can be substantially comparable, but do not need to be, e.g., precisely the same type of units.

According to exemplary embodiments, dimensions and their corresponding elements within tuples are identified by their index number. For example, in the tuple {processor capacity, memory capacity, driver capacity}, the dimension associated with processor capacity could have an index of [0], the dimension associated with memory capacity could have an index of [1], and the dimension associated with driver capacity could have an index of [2]. Availability managers and the like which evaluate and store tuples according to these exemplary embodiments will thus be able to ensure that elements associated with the same dimension are being compared and manipulated as part of the task distribution process.

Tasks according to these exemplary embodiments do not necessarily need to be explicitly characterized in all dimensions, instead a task may, for example, only be characterized using those elements which it uses or enables. For example, in a three dimensional system wherein loads and capacities are expressed using the ordered tuple {processor capacity, memory capacity, driver capacity}, an application which has a load of {1, 1, 0} can alternatively be characterized as {1₀, 1₁], i.e., using some explicit indication of each element's index value and omitting zero values. Then, a node or availability manager processing tuples which are formatted in this way will assume a zero capacity or load for unspecified elements (dimensions) in each tuple.

The foregoing exemplary embodiments describe methods, systems, devices and software for dynamic load management including the use of tuples to characterize capacities of resources and loads of assignments or tasks. An exemplary node 600 on which an availability manager 400, 500 can operate, or which alternatively represents a node whose capacity is characterized using the aforedescribed tuples, is illustrated as FIG. 6. Therein, node 600 contains a processor 602 (or multiple processor cores), memory 604, one or more secondary storage devices 606 and an interface unit 608 to facilitate communications between network node 600 and the rest of the network, e.g., the remaining ones of availability manager 400, 500 and nodes n1-n3. The memory (or the secondary storage) can be used for storage of, e.g., tables 510 including utilization tuples as described above, load tuples and/or capacity tuples according to these exemplary embodiments.

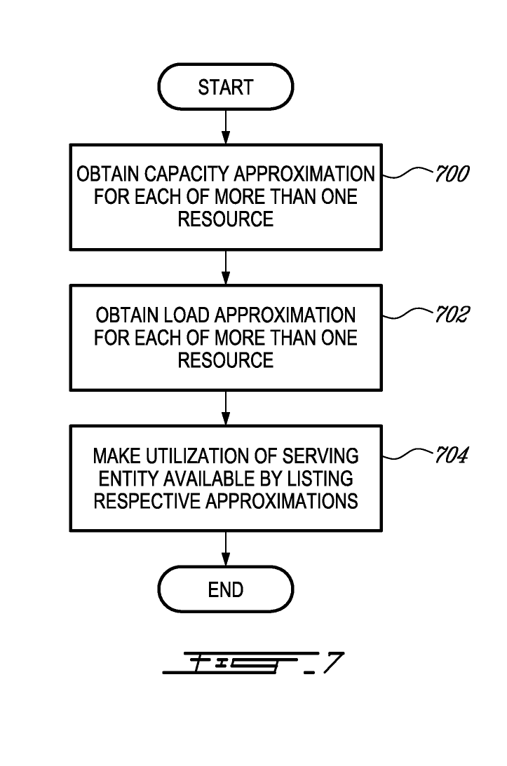

A method for making load characteristics of a serving entity available is illustrated in the flowchart of FIG. 7. Therein, a capacity approximation of a serving entity is obtained for each one of more than one resource at step 700. A load approximation of the serving entity is also obtained for each one of the more than one resource at step 702. A utilization of the serving entity is then made available by listing a respective capacity approximation and load approximation for each one of the more than one resource at step 704. As will be appreciated by those skilled in the art, methods such as that illustrated in FIG. 7 can be implemented in software. Thus, systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

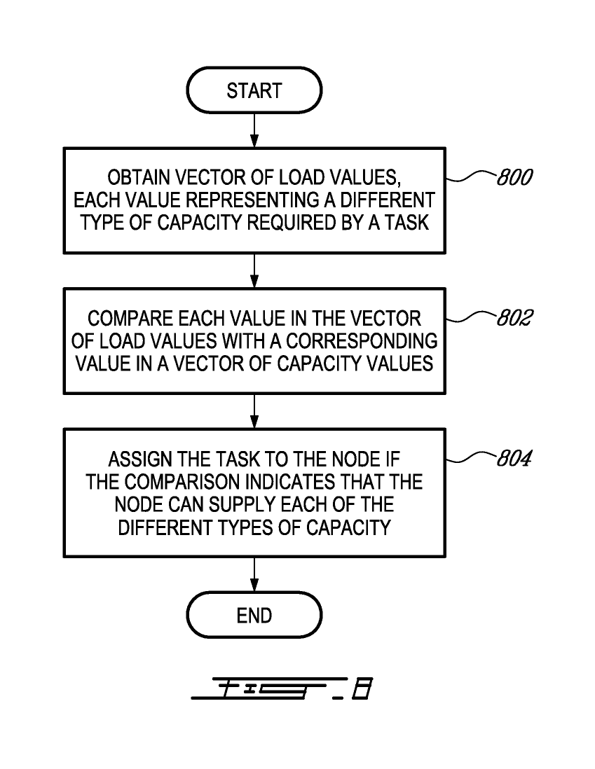

Other such methods according to these exemplary embodiments can also be implemented in software and/or hardware. For another example, a method for assigning a task to a node in a network according to an exemplary embodiment is illustrated in the flowchart of FIG. 8. Therein, a vector of load values associated with the task is obtained at step 800, wherein each value in the vector represents a different type of capacity required by the task. Each value in the vector of load values is compared with a corresponding value in a vector of capacity values associated with the node at step 802. The task is assigned to the node if the comparison indicates that the node can supply each of the different types of capacity required by the task.

In some cases each element of the task tuples may relate to a load dimension that is required by the task in order to enable the task to operate on a particular node, such that a comparison of each element in the task tuple with a corresponding element in a capacity tuple of a resource should be performed and satisfied in order to warrant assignment of that task to that particular node. In other implementations it may be possible that the task tuple includes element(s) which relate to mandatory load requirements but also element(s) which relate to optional or preferred load dimensions, e.g., dimensions which may, if present on a node, enhance the performance or operation of the task but which are not actually a prerequisite to the task being performed by a given node. In the latter case, for mandatory load elements, all such elements must be met (i.e., a corresponding free capacity must be found in a node, for that node to be a candidate to be assigned this task), for optional load elements, none of these elements need to be met (i.e., it is not necessary that a corresponding free capacity be found in a node for that node to be a candidate). If more than one node can serve the mandatory loads, preference can be given to the node that can provide most of the optional loads.

The actual values used in tuples according to these exemplary embodiments to characterize capacities and/or loads may be arrived at in a variety of ways. For example, such values could be derived from historical data, measurements or approximations. Approximate capacity and/or load values could be quite rough, e.g., order of magnitude, rather than very precise. Nonetheless, even using rough approximate values for capacities and loads, these exemplary embodiments provide benefits by facilitating the matching of tasks to resources across a number of different performance dimensions.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for making load characteristics of a serving entity available, wherein the serving entity is a logical or physical entity, the method comprising steps of:
obtaining a capacity approximation of the serving entity for each one of more than one resource;
obtaining a load approximation of the serving entity for each one of the more than one resource; and
making a utilization of the serving entity available by listing a respective capacity approximation and load approximation for each one of the more than one resource.

2. The method of claim 1, wherein the step of making available further comprises:
juxtaposing the respective capacities and load approximations of the more than one resource in the form of an advertised tuple.

3. The method of claim 1, wherein the step of making available further comprises:
representing the load characteristics with a load ratio for each of the more than one resource.

4. The method of claim 2, further comprising a step of:
modifying the advertised tuple of the serving entity by adding an update tuple to the advertised tuple, wherein the update tuple comprises a positive or negative differential value for each of the more than one resource of the advertised tuple.

5. The method of claim 4, wherein the step of modifying is performed upon assignment of a new task to the serving entity.

6. The method of claim 4, wherein each differential value is a single value for each of the more than one resource that affects either the approximation of the load values or the capacity values of the advertised tuple.

7. The method of claim 4, wherein each differential value is a pair of values for each of the more than one resource that affects both the approximation of the load values and the capacity values of the advertised tuple.

8. The method of claim 1, wherein the approximation is derived from at least one of: historical data, manual inputs, and measurements.

9. The method of claim 1, wherein the more than one resource is more than two resources.

10. A method for assigning a task to a node in a network comprising:
obtaining a vector of load values associated with said task, each value in said vector representing a different type of capacity associated with said task;
comparing at least one value in said vector of load values with a corresponding value in a vector of capacity values associated with said node; and
assigning said task to said node if said comparing indicates that said node can supply at least one of said different types of capacity associated with said task.

11. The method of claim 10, wherein said step of comparing further comprises:
comparing each value in said vector of load values with said corresponding value in a vector of capacity values; and wherein said step of assigning further comprises:
assigning said task to said node only if said comparing indicates that said node can supply each of said different types of capacity required by said task.

12. The method of claim 10, wherein said vector of load values and said vector of capacity values are indexed such that values having a same index are compared with one another.

13. The method of claim 10, wherein said vector of load values includes a zero value associated with a type of capacity that is not required by said task.

14. The method of claim 10, wherein said vector of capacity values includes a zero value associated with a type of capacity that is not currently available at said node.

15. The method of claim 10, wherein said different types of capacity include at least one hardware capacity.

16. The method of claim 10, wherein said different types of capacity include at least one software capacity.

17. The method of claim 10, wherein said vector of load values includes a negative value associated with a type of capacity that is provided to said node when said task is assigned to said node.

18. The method of claim 10, further comprising:
combining said vector of load values with said vector of capacity values to generate an updated vector of capacity values; and
storing said updated vector of capacity values.

19. A device comprising:
a memory device for storing vectors of load values associated with tasks to be assigned, each value in each of said vectors of load values representing a different type of capacity associated with a respective task, and for storing vectors of capacity values associated with nodes which can perform tasks, each value in each of said vectors of capacity values representing said different type of capacity provided by a respective node; and
a processor which compares at least one value in a selected vector of load values associated with a task to be assigned with a corresponding value in a selected vector of capacity values associated with one of said nodes, and which assigns said task to said node if said comparison indicates that said node can supply at least one of said different types of capacity associated with said task.

20. The device of claim 19, wherein said processor compares each value in said vector of load values with said corresponding value in a vector of capacity values; and assigns said task to said node only if said comparison indicates that said node can supply each of said different types of capacity required by said task.

21. The device of claim 19, wherein said vectors of load values and said vectors of capacity values are indexed such that values having a same index are compared with one another.

22. The device of claim 19, wherein said selected vector of load values includes a zero value associated with a type of capacity that is not required by said task to be assigned.

23. The device of claim 19, wherein said selected vector of capacity values includes a zero value associated with a type of capacity that is not currently available at said one of said nodes.

24. The device of claim 19, wherein said different types of capacity include at least one hardware capacity.

25. The device of claim 19, wherein said different types of capacity include at least one software capacity.

26. The device of claim 19, wherein said selected vector of load values includes a negative value associated with a type of capacity that is provided to said one of said nodes when said task is assigned to said one of said nodes.

27. The device of claim 19, wherein, after assigning said task to said one of said nodes, said processor updates said selected vector of capacity values associated with said one of said nodes by combining said selected vector of capacity values with said selected vector of load values and stores said updated vector in said memory device.
